(19) United States
(12) Patent Application Publication
(10) Pub. No.: US 2023/0200273 A1
(43) Pub. Date: Jun. 29, 2023

(54) ADAPTABLE AND ADJUSTABLE GROUND-CONTACT OPERATED WEED PULLING DEVICE

(71) Applicants: Clay Martin Jackson, Peralta, NM (US); Thuy Thi Hong Nguyen, Peralta, NM (US)

(72) Inventors: Clay Martin Jackson, Peralta, NM (US); Thuy Thi Hong Nguyen, Peralta, NM (US)

(21) Appl. No.: 17/561,324

(22) Filed: Dec. 23, 2021

(51) Int. Cl. A01B 1/16; A01M 21/02

(52) U.S. Cl. CPC A01B 1/16; A01M 21/02

(57) ABSTRACT

A weeding device provides leverage for pulling a deeply-rooted plant from soil without requiring excessive foot pressure for operation. A handle is attached to a weeder head having a first fork extending away from the end of the handle. A rotating jaw is mounted to the weeder head, and has a second fork displaced from the first fork when the second fork are parallel. The weeding device has a step for applying foot pressure to insert the first and second forks in the soil prior. A lever extension of the rotating jaw on an opposite side of the handle contacts the soil when the forks are fully inserted in the soil, and as the handle is rotated toward the soil a tip of the second fork inclines toward a tip of the first fork to close the first fork and the second fork around a plant.

### BACKGROUND OF THE INVENTION

### 1. Field of the Invention

The present invention relates generally to garden weeders and other manually-operated weeding devices for use in removing weeds from soil.

### 2. Description of the Related Art

Hand and foot-operated weeding tools have long been in-use for removing garden weeds and transplanting plants. The weeding tools typically operate using a lever to which foot pressure is applied to insert one or more forks into the soil around a weed, and then, using leverage produced by tilting a handle backward toward the operator, together with pushing on a lever with a foot, the forks are brought together and tilted out of the soil to extract the weed.

However, existing designs are limited in that as the handle is tilted backward, foot pressure is lost due to the operator having to remove their foot if the handle must be tilted deeply for grasping deeply-rooted weeds. While such devices are suitable for shallow soil penetration, the grasping force and angle needed to extract deeper weeds makes their use unsuitable for that purpose. Further, existing designs are not adaptable to different soil conditions and weed root depth, placing all of the compensation for such variations on the operator attempting to use the tool for different soil conditions and weed depth.

Therefore, it would be desirable to provide a manually-operated weeding tool that can adapt to different soil and weed depth conditions, and that provides gripping strength that is not dependent on weight applied by a foot increasing during a weed extraction maneuver.

### SUMMARY OF THE INVENTION

The above objectives, among others, are achieved in a manually-operated weeding device and its method of operation in use.

The weeding device is a device for pulling a plant from soil, and includes an elongate handle and a weeder head affixed to the handle at an end of the handle. The weeder head includes a first fork extending along a long direction of the handle and away from the end of the handle and a rotating jaw rotatably mounted to the weeder head by an axle extending in a first direction perpendicular to the long direction of the handle. The rotating jaw has a second fork displaced from the axle in a second direction perpendicular to the long direction of the handle and perpendicular to the first direction on a first side of the handle, so that the second fork is displaced from the first fork when the second fork is rotated to be parallel to the first fork. The weeder head further includes a step rigidly affixed to the weeder head and extending along the second direction on a second side of the handle opposite the first side to provide a platform for applying foot pressure to insert the first and second forks in the soil prior to rotating the handle. The rotating jaw has a lever extension mechanically coupled to and extending from the second fork to an end of the lever extension on the second side of the handle, so that the lever extension contacts the soil when the first fork and the second fork are fully inserted in the soil, and so that as the handle is rotated toward the soil, the lever extension rotates with respect to the handle due to contact of the edge of the lever extension with the soil and causes a tip of the second fork to incline toward a tip of the first fork to close the first fork and the second fork around a plant.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a perspective view of an example weeding tool 10, according to an embodiment of the disclosure.

FIG. 2A is a front view, FIG. 2B is a side view, and FIG. 2C is a bottom end view of example weeding tool 10 of FIG. 1.

FIG. 3 is an exploded perspective view of example weeding tool 10 of FIG. 1.

FIGS. 4A-4C are pictorial views illustrating operation of example weeding tool 10 of FIG. 1, in accordance with an embodiment of the disclosure.

FIG. 5A is a perspective view, FIG. 5B is a front view, FIG. 5C is a side view, and FIG. 5D is a bottom end view of fixed portions of an example weeder head 20 that may be used in example weeding tool 10 of FIG. 1, in accordance with an embodiment of the disclosure.

FIG. 6A is a perspective view, FIG. 6B is a front view, FIG. 6C is a side view, and FIG. 6D is a bottom end view of an example rotating jaw 25A that may be used in example weeding tool 10 of FIG. 1, in accordance with an embodiment of the disclosure.

FIG. 7A is a perspective view, FIG. 7B is a front view, FIG. 7C is a side view, and FIG. 7D is a bottom end view of an example rotating jaw 25B that may be used in example weeding tool 10 of FIG. 1, in accordance with another embodiment of the disclosure.

FIG. 8A is an enlarged side view of fixed portions of example weeder head 20 as shown in FIG. 5C.

FIG. 8B is an enlarged side view of example rotating jaw 25A as shown in FIG. 6C.

FIG. 8C is an enlarged side view of example rotating jaw 25B as shown in FIG. 7C.

### DETAILED DESCRIPTION OF ILLUSTRATIVE EMBODIMENT

The present disclosure encompasses new weeding devices, their methods of operation and weeder heads that provide significant advantages in removing weeds in difficult soil conditions and weeds with deep roots. i.e., weeding in conditions that ordinarily require large amounts of weight to be applied to a weeding tool. The weeding device provides leverage for pulling a deeply-rooted plant from soil without requiring excessive foot pressure for operation. A handle is attached to a weeder head having a first fork extending away from the end of the handle. A rotating jaw is mounted to the weeder head, and has a second fork displaced from the first fork when the second fork are parallel. The weeding device has a step for applying foot pressure to insert the first and second forks in the soil prior. A lever extension of the rotating jaw on an opposite side of the handle contacts the soil when the forks are fully inserted in the soil, and as the handle is rotated toward the soil a tip of the second fork inclines toward a tip of the first fork to close the first fork and the second fork around a plant. The lever extension may include two lever extensions on either face of the weeding tool, so that the application of extraction force is balanced on both sides of the tool.

In at least one example embodiment, the forks of the weeding device are capable of completely entering the soil to their full tine length, and rather than stepping on the element that provides leverage to close the forks, i.e., the lever extension(s) of the rotating jaw that contact the soil during weed extraction, a separate step is provided that is rigidly attached to the handle. In the disclosed embodiments, the pivot point of the rotating jaw lever extension(s) is located near the end of the handle and moves with the handle as the handle is rotated, which increases the gripping force provided between the forks, while minimizing the torque that must be supplied to the handle to close the forks together. The forks are closed together immediately as the handle is rotated and are both in movement, the first fork due to the rotation of the handle, the second fork due to the rotation of the rotating jaw caused by the contact of the lever extension(s) with the soil as the handle is rotated. Such operation is suitable for extracting weeds including those with very deep roots and those implanted in very tough soils, as the force that brings the forks together due to the contact of the lever extension(s) with the soil increases as the torque applied to the handle is increased.

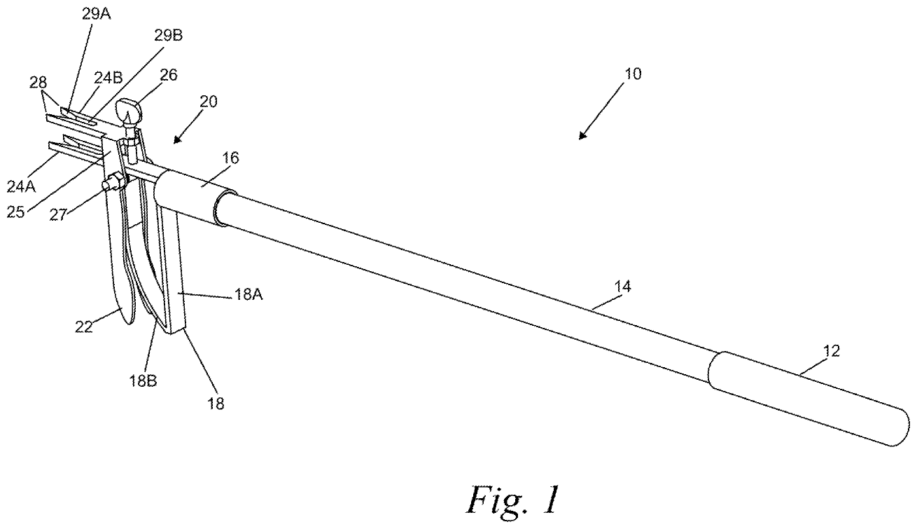

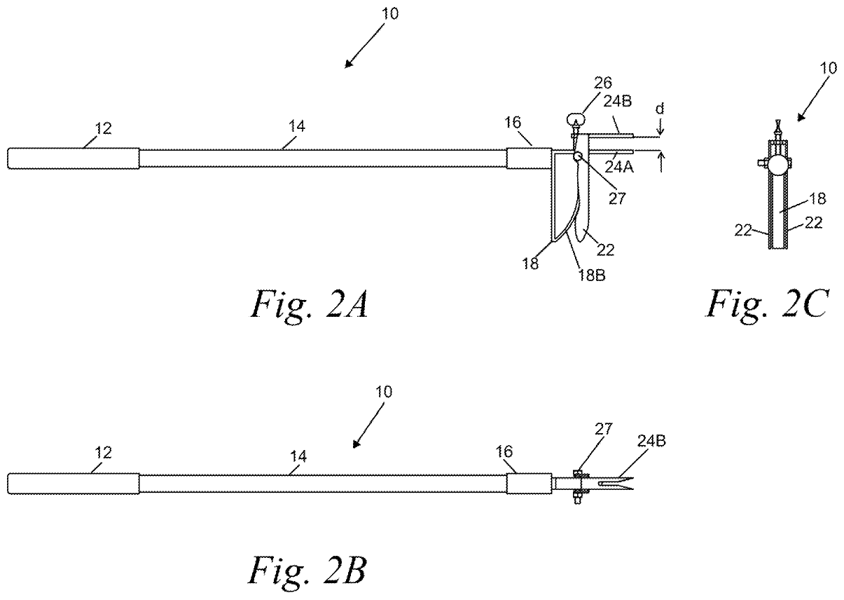

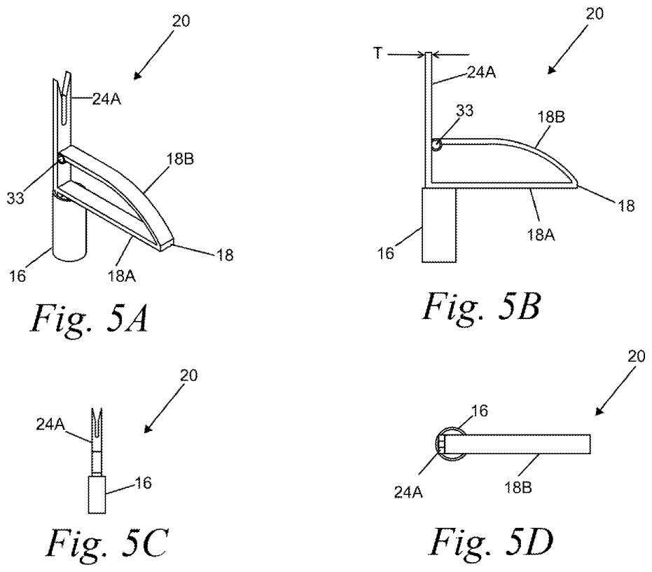

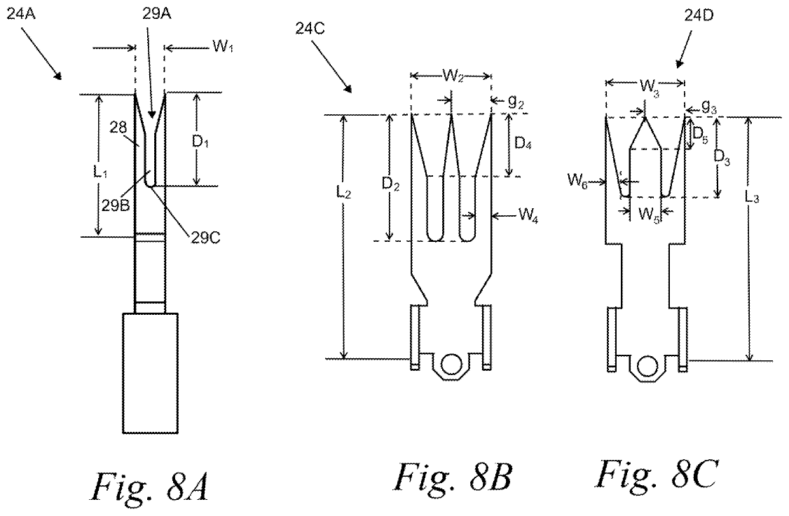

Referring now to FIG. 1, a perspective view of an example weeding tool 10 is shown, according to an embodiment of the disclosure. A handle 14 includes a grip portion 12 which may be, for example, a plastic or rubber cover slid over handle 14 to provide a hand gripping area on handle. A weeder head 20 is attached to handle 14 by insertion of the end of handle 14 opposite grip 12 into a sleeve 16 of weeder head 20. A step 18 provides the force for inserting tines 28 of a pair of forks 24A, 24B into soil, and includes a step portion 18A for receiving pressure from a foot of an operator of weeding tool 10 that provides the fork insertion force, and a curved support portion 18B. Fork 24A is rigidly connected to sleeve 16, e.g., by welding, and may be integral with the metal bar forming step 18, which may then be welded or otherwise attached to sleeve 16. Fork 24B is rigidly connected to a rotating jaw 25 that is secured to weeder head 20 by an axle 27, which in the exemplary embodiment, is supplied by a removable bolt. Rotating jaw 25 terminates in a pair of lever extensions 22 that contact the soil as handle 14 is rotated in the direction of step 18 (generally toward the operator) and cause tines 28 of forks 24A, 24B to come together to grip a weed. An adjustment mechanism 26 is supplied by a thumb-turn bolt inserted in a threaded hole provided in a frame of rotating jaw 25 and sets an initial distance between the tips of tines 28. The initial distance is nominally 1 inch between forks 24A and 24B, which are parallel at that adjustment point, but adjustment mechanism 26 provides for adjustment on either side of the nominal adjustment point, so that forks 24A and 24B may form an acute or obtuse angle therebetween, depending on the requirements for pulling particular weeds. Referring additionally to FIG. 8A, which shows an enlarged view of fork 24A, the tip features of which are the same as those of fork 24B, forks 24A, 24B have a separation width W₁ of ¾-inch at the tips of tines 28, and an overall length L₁ of 4 inches that extends from the tips of tines 28 to the center of rotation of rotating jaw 25. The inter-tine depth D₁ of forks 24A, 24B is 2 inches, and the thickness T of forks 24A, 24B is ¼ inch (as shown in FIG. 5B). The unadjusted displacement d between forks 24A, 24B in the direction of handle 14 at axle 27 is one inch (as shown in FIG. 2A), which gives a gripping strength to extract a wide range of roots with sufficient gripping strength to extract the roots. Rotating jaw 25 is removable and may be interchanged with other designs as described below, depending on the particular soil conditions, types of weeds that are to be extracted, and also depending on the tolerable disturbance of the soil. Rotating jaw 25 provides a combination of soil penetration and gripping surface area that allows the user to extract small weeds from lawns or landscape, but also has the ability to extract larger weeds. Forks 24B (as well as fixed forks 24A) provide a slim profile that can penetrate deeply into moderate-to-hard soils with ease in extracting the weed with entirety of the root. The design of forks 24B also limit the amount of soil removed with the root, thereby minimizing the size of divots produced in the soil/lawn when extracting a weed. Forks 24B also have a taper that is formed. The two-tine design of forks 24A, 24B have a two-step taper between tines 28, which is formed by a “V”-shaped opening 29A that reduces to a slot 29B with a curved termination 29C, which admits enough soil for compression around the root that provides clamping pressure that will hold the root in place between the opposing forks 24A, 24B for removal of the root when handle 14 is rotated. The spacing between tines 28 allows for the pulling of large weeds with thick root bases through clamping but also a “wedging” action between tines 28. However, the design of forks 24A, 24B does require a more precise placement of forks 24A, 24B over a weed, so that the weed base or root will be wedged in between tines 28 of either or both of forks 24A, 24B, so that the root base is gripped by a combination of wedging between tines 28 and clamping pressure applied between forks 24A, 24B.

Referring now to FIGS. 2A-2C, a front view, a side view, and a bottom end view of example weeding tool 10 of FIG. 1 are shown, respectively, in accordance with an embodiment of the disclosure. Details of the shape of the bar forming step 18 and fork 24A are illustrated, as well as the initial spatial relationship between lever extensions 22 and curved support portion 18A of step 18, which, contrary to the curved foot of some manual weeding devices, is curved for the purpose of avoiding contact with the soil as lever extension(s) 22 contact the soil and rotating jaw 25 rotates around axle 27, rather than curved support portion 18A contacting the soil to provide a base for rotation, as in some existing weeder designs.

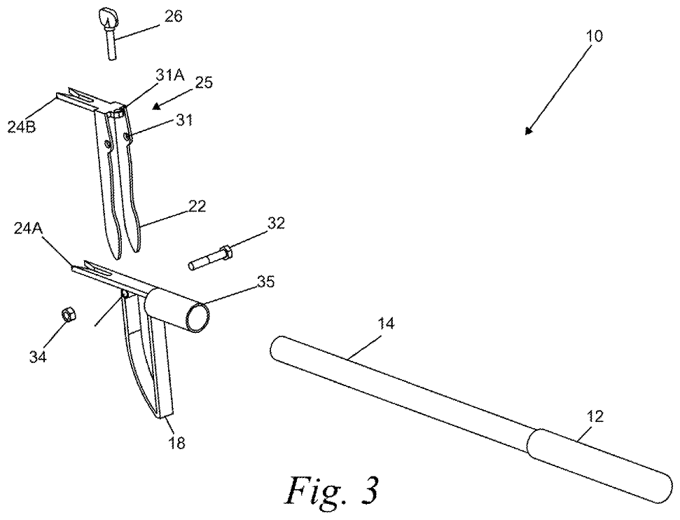

Referring now to FIG. 3, an exploded perspective view of example weeding tool 10 of FIG. 1 is shown, in accordance with an embodiment of the disclosure. The structure of axle 27 can be seen, which includes a cylindrical bushing 33 welded to curved support portion 18A, or which may be formed as part of the rolling of the bar that forms step 18 and fork 24A. A bolt 32 is inserted through holes in rotating jaw 25 and through cylindrical bushing 33 to form axle 27 and is secured with a nut 34, providing a simple, removable axle, that can be used to interchange rotating jaw 25. Adjustment mechanism 26 is supplied by a thumb bolt threaded into a threaded hole 31A in rotating jaw 25 and may be adjusted to set the initial displacement between the tips of forks 24A, 24B.

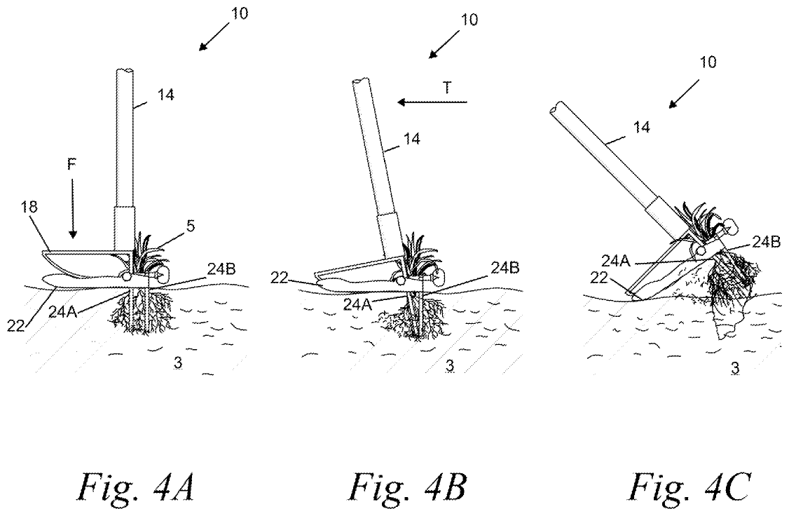

Referring now to FIGS. 4A-4C, pictorial views illustrate operation of example weeding tool 10 of FIG. 1, in accordance with an embodiment of the disclosure. In FIG. 4A, downward force F from a foot applied to step 18 has inserted forks 24A, 24B into soil 3 around a plant 5. Lever extensions 22 contact soil 3 before the bottom of step 18, so that when a torque T is applied to handle 14 as illustrated in FIG. 4B, lever extension 22 are forced upward (clockwise rotation in the opposite rotational direction to torque T), which closes fork 24B around the roots of plant 5. As handle 14 continues to rotate toward soil 3, the closed forks 24A, 24B are lifted from soil 3, extracting plant 5.

Referring now to FIGS. 5A-5D, a perspective view, a front view, a side view, and a bottom view FIG. 5D is a bottom end view, respectively, of fixed portions of an example weeder head 20 that may be used in example weeding tool 10 of FIG. 1, are shown in accordance with an embodiment of the disclosure. Detailed locations of bushing 33 and the shape of step 18 are shown, along with the shape of time 24A.

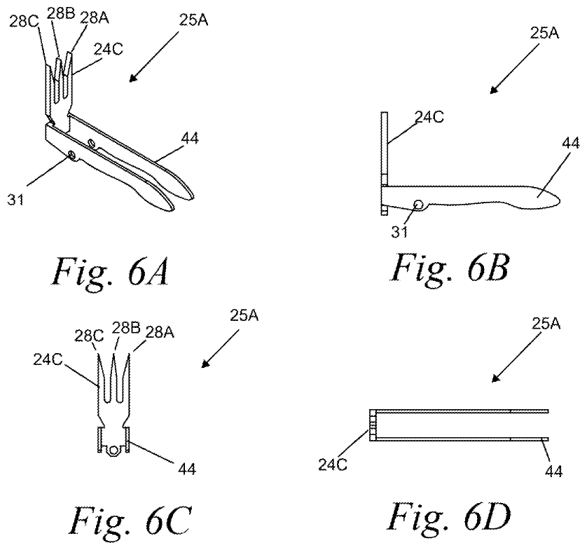

Referring now to FIGS. 6A-6D, a perspective view, a front view, a side view, and a bottom end view, respectively, are shown of an example rotating jaw 25A that may be used in example weeding tool 10 of FIG. 1, in accordance with an embodiment of the disclosure. Fork 24C differs from fork 24B as illustrated in example weeding tool 10 of FIGS. 1-3, in that fork 24B has three tines 28A, 28B, 28C of approximately equal width and depth, that permit tines 28 of fixed fork 24A to intermesh with fork 24C, i.e., tines 28 fit between pairs of tines 28A, 28B and 28B, 28C, which allows rotating jaw 25A to rotate farther than rotating jaw 25 of FIGS. 1-4 as handle 14 is rotated to press a pair of lever extensions 44 against the soil, providing a “scissoring” action that provides greater clamping between fork 24C and fixed fork 24A. The amount of intermesh may be controlled by adjusting adjustment mechanism 26, according to the base width of the weeds to be pulled, or the amount of soil to be used as a clamping media between forks 24A, 24C. By removing nut 34 from bolt 32, and removing rotating jaw 25 from example weeding tool 10, rotating jaw 25 may be replaced with rotating jaw 25A, when difficult extraction conditions are anticipated or encountered. Jaw 25A may be included as a kit part along with rotating jaw 25 in sales of example weeding tool 10, so that example weeding tool 10 may be adapted to various conditions. The use of jaw 25A greater clamping pressure via the scissoring action in combination with soil compaction between forks 24A, 24C, and allows for greater latitude in pulling weeds due to the broad surface area provided by the three tines 28A, 28B, 28C of fork 24C, less precision may be required in tool placement over a weed. The scissoring action make it easy to clamp a weed with rotating jaw 25A, which may provide rapid operation with large weeds using minimum soil penetration, or grasping of large weeds with shallow roots between forks 25A and 22C above the soil. While rotating jaw 25A is effective on both large and small weeds due to the greater clamping area and scissor action, a larger divot may be produced in lawns due to removal of a greater amount of soil around a root. The greater surface area may make soil penetration in moderate to hard soils slightly more difficult than using rotating jaw 25, if similar penetration depth is needed. Referring additionally to FIG. 8B, which shows an enlarged view of fork 24C, fork 24C has a width W₂ of 1¼ inch at the tips of tines 28A-28C, and an overall length L₂ of 4 inches that extends from the tips of tines 28A-28C to the center of rotation of rotating jaw 25A. The inter-tine depth D₂ of fork 24C is 2 inches, and the thickness T of fork 24C is ¼ inch. A gap g₂ between the tips of tines 28A and 28B and between 28B and 28C is ⅝ inch, so that the total width W₂ of fork 24C is 1¼ inches. The tips of tines 28A and 28C increase to a width W₄ of ¼ inch at a depth D₄ of 1 inch. At depth D₂, the width of the gaps between tines 28A and 28B and between 28B and 28C is ¼ inch, so that the total width W₂ of fork 24C remains 1¼ inches.

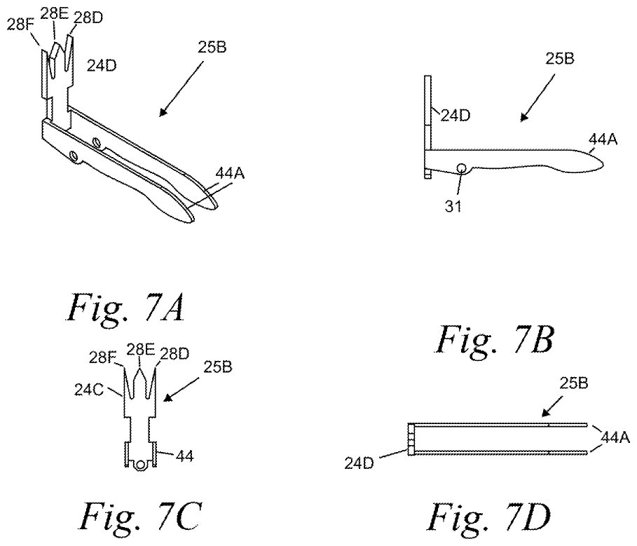

Referring now to FIGS. 7A-7D, a perspective view, a front view, a side view, and a bottom end view, respectively, are shown of another example rotating jaw 25B that may be used in example weeding tool 10 of FIG. 1, in accordance with an embodiment of the disclosure. Fork 24D differs from fork 24B as illustrated in example weeding tool 10 of FIGS. 1-3, in that fork 24B has three tines 24D, 24E and 24F of differing width, and inter-tine grooves that are shallow, with the inter-tine surfaces of tines 28D, 28F inclined toward central tine 28E throughout the tine length. Rotating jaw 25B may be provided in a kit and interchanged with rotating jaw 25 as with rotating jaw 25A of FIGS. 6A-6D, and is useful for extracting weeds in loose soil, such as sand. The shorter tine length of 24D, 24E and 24F, along with wider central tong 24E provides greater surface area for gripping a weed head and top portion of a root. Rotating jaw 25B provides greater contact with the soil and root at all depths. In looser soil, the greater surface area of tines 24D, 24E and 24F is able to penetrate deep into the soil and provide a greater opportunity to clamp a root. Rotating jaw 25B also provides for inter-mesh of tines 24D, 24E and 24F with tines 28 of fixed fork 24 that may be adjusted via adjustment mechanism 26. By removing nut 34 from bolt 32, and removing rotating jaw 25 from example weeding tool 10, rotating jaw 25 may be replaced with rotating jaw 25B, when such conditions are anticipated or encountered. Rotating jaw 25B may be included as a kit part along with rotating jaw 25 (and rotating jaw 25A) in sales of example weeding tool 10, so that example weeding tool 10 may be adapted to various conditions. All of the rotating jaws 22, 25A and 25B described above provide a mechanism whereby the more resistant a weed is to the pressure applied between forks, the more clamping pressure example clamping tool 10 applies through the leverage provided between rotation of handle 14 and contact of a pair of lever extensions 44A with the soil. Referring additionally to FIG. 8C, which shows an enlarged view of fork 24D, fork 24D has a width W₃ of 1¼ inch at the tips of tines 28D-28F, and an overall length L₃ of 4 inches that extends from the tips of tines 28D-28F to the center of rotation of rotating jaw 25B. The inter-tine depth D₃ of fork 24D is 1¼ inches, and the thickness T of fork 24D is ¼ inch. A gap g₃ between the tips of tines 28D and 28E and between 28E and 28F is ⅝ inch, so that the total width W₃ of fork 24D is 1¼ inches. The tips of tines 28D and 28F increase to a width W₄ of ¼ inch at a depth D₄ of 1¼ inches. At depth D₃, the width of the gaps between tines 28D and 28E and between 28E and 28F is ⅛ inch and a width W₅ of tine 28E at the bottom of the gaps is ½ inch, so that so that width of tines 28D and 28F at their base is ¼ inch, so that the total width W₃ of fork 24C remains 1¼ inches.

In summary, this disclosure shows example weed pulling devices for pulling a plant from soil, example weeder heads for use in the example weed pulling device and their methods of operation. The weed pulling device includes an elongate handle and a weeder head fixedly mounted to the handle at an end of the handle. The weeder head may include a first fork extending along a long direction of the handle and away from the end of the handle, and a rotating jaw rotatably mounted to the weeder head by an axle extending in a first direction perpendicular to the long direction of the handle. The rotating jaw may have a second fork displaced from the axle in a second direction perpendicular to the long direction of the handle and perpendicular to the first direction on a first side of the handle, so that the second fork is displaced from the first fork when the second fork is rotated to be parallel to the first fork. The weeder head may further include a step rigidly affixed to the weeder head and extending along the second direction on a second side of the handle opposite the first side to provide a platform for applying foot pressure to insert the first and second forks in the soil prior to rotating the handle. The rotating jaw may have a lever extension mechanically coupled to and extending from the second fork to an end of the lever extension on the second side of the handle, so that the lever extension contacts the soil when the first fork and the second fork are fully inserted in the soil, and so that as the handle is rotated toward the soil, lever extensions rotate with respect to the handle due to contact of the edge of lever extensions with the soil and causes a tip of the second fork to incline toward a tip of the first fork to close the first fork and the second fork around a plant.

In some example embodiments, the step may have a curved support portion that extends from the axle to a first end of a step that extends to the handle at a second end thereof an in a direction perpendicular to the long direction of the handle. The edge of the lever extension may extend beyond the curved support portion of the step, so that the curved support portion of the step does not prevent contact of the soil with the edge of the lever extension during operation of the weed pulling device. In some example embodiments, the weed pulling device may include an adjustment mechanism for adjusting a distance between the tip of the first fork and a tip of the second fork, thereby adjusting an initial rotation of the edge of the lever extension with respect to the handle.

In some example embodiments, the rotating jaw may be a first rotating jaw rotatably coupled to the axle at a first end of the axle, and the weeder head may further include a second rotating jaw rotatably coupled to the axle at a second end of the axle, wherein the first rotating jaw may be rigidly attached to a first side of the second fork and the second rotating jaw may be rigidly attached to a second side of the second fork, so that the first and second rotating jaws may pass on either side of the step when the first lever extension and the second lever extension rotate with respect to the handle due to contact of the edge of the first lever extension and a corresponding edge of the second lever extension with the soil. In some example embodiments an end of the edge of the first lever extension and the corresponding edge of the second lever extension opposite the second fork may be curved in a direction away from a tip of the second fork, so that as the handle is rotated toward the soil, an angular rotation of the second fork with respect to the first fork around the axle is reduced with respect to the rotation of the handle as the handle is rotated toward the soil. In some example embodiments, an end of the edge of the lever extension opposite the second fork may be curved in a direction away from a tip of the second fork so that as the handle is rotated toward the soil, an angular rotation of the second fork with respect to the first fork around the axle may be reduced with respect to the rotation of the handle as the handle is rotated toward the soil. In some example embodiments, the lever extension may be rigidly coupled to the second fork.

In some example embodiments, the axle may be removably coupled to the weeder head, and the second fork may be one of a plurality of interchangeable fork assemblies that can be removed and interchanged for rotatable attachment to the weeder head. In some example embodiments, the plurality of interchangeable fork assemblies may include fork assemblies having forks with differing tine lengths.

It should be understood, especially by those having ordinary skill in the art with the benefit of this disclosure, that the various operations described herein, particularly in connection with the figures, may be implemented by other components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense. Similarly, although this disclosure makes reference to specific embodiments, certain modifications and changes may be made to those embodiments without departing from the scope and coverage of this disclosure. Moreover, any benefits, advantages, or solutions to problems that are described herein with regard to specific embodiments are not intended to be construed as a critical, required, or essential feature or element.

While the disclosure has shown and described particular embodiments of the techniques disclosed herein, it will be understood by those skilled in the art that the foregoing and other changes in form, and details may be made therein without departing from the spirit and scope of the disclosure.

What is claimed is:

1. A weed pulling device for pulling a plant from soil, the weed pulling device, comprising:
an elongate handle;
a weeder head fixedly mounted to the handle at an end of the handle, wherein the weeder head includes a first fork extending along a long direction of the handle and away from the end of the handle, and a rotating jaw rotatably mounted to the weeder head by an axle extending in a first direction perpendicular to the long direction of the handle, wherein the rotating jaw has a second fork displaced from the axle in a second direction perpendicular to the long direction of the handle and perpendicular to the first direction on a first side of the handle, so that the second fork is displaced from the first fork when the second fork is rotated to be parallel to the first fork, wherein the weeder head further includes a step rigidly affixed to the weeder head and extending along the second direction on a second side of the handle opposite the first side to provide a platform for applying foot pressure to insert the first and second forks in the soil prior to rotating the handle, wherein the rotating jaw has a lever extension mechanically coupled to and extending from the second fork to an end of the lever extension on the second side of the handle, so that the lever extension contacts the soil when the first fork and the second fork are fully inserted in the soil, and so that as the handle is rotated toward the soil, the lever extension rotates with respect to the handle due to contact of the edge of the lever extension with the soil and causes a tip of the second fork to incline toward a tip of the first fork to close the first fork and the second fork around a plant.

2. The weed pulling device of claim 1, wherein the step has a curved support portion that extends from the axle to a first end of a step that extends to the handle at a second end thereof an in a direction perpendicular to the long direction of the handle, wherein the edge of the lever extension extends beyond the curved support portion of the step, so that the curved support portion of the step does not prevent contact of the soil with the edge of the lever extension during operation of the weed pulling device.

3. The weed pulling device of claim 1, further comprising an adjustment mechanism for adjusting a distance between the tip of the first fork and a tip of the second fork, and thereby adjusting an initial rotation of the edge of the lever extension with respect to the handle.

4. The weed pulling device of claim 1, wherein the rotating jaw is a first rotating jaw rotatably coupled to the axle at a first end of the axle, and wherein the weeder head further comprises a second rotating jaw rotatably coupled to the axle at a second end of the axle, wherein the first rotating jaw is rigidly attached to a first side of the second fork and the second rotating jaw is rigidly attached to a second side of the second fork, so that the first and second rotating jaws pass on either side of the step when the first lever extension and the second lever extension rotate with respect to the handle due to contact of the edge of the first lever extension and a corresponding edge of the second lever extension with the soil.

5. The weed pulling device of claim 4, wherein an end of the edge of the first lever extension and the corresponding edge of the second lever extension opposite the second fork are curved in a direction away from a tip of the second fork, so that as the handle is rotated toward the soil, an angular rotation of the second fork with respect to the first fork around the axle is reduced with respect to the rotation of the handle as the handle is rotated toward the soil.

6. The weed pulling device of claim 1, wherein an end of the edge of the lever extension opposite the second fork is curved in a direction away from a tip of the second fork so that as the handle is rotated toward the soil, an angular rotation of the second fork with respect to the first fork around the axle is reduced with respect to the rotation of the handle as the handle is rotated toward the soil.

7. The weed pulling device of claim 1, wherein the lever extension is rigidly coupled to the second fork.

8. The weed pulling device of claim 1, wherein the axle is removably coupled to the weeder head, and the second fork is one of a plurality of interchangeable fork assemblies that can be removed and interchanged for rotatable attachment to the weeder head.

9. The weed pulling device of claim 8, wherein the plurality of interchangeable fork assemblies include fork assemblies having forks with differing tine lengths.

10. A method of operating a weed pulling device to pull a plant from soil, the method comprising:
affixing a weeder head to an elongate handle at an end of the handle, wherein the weeder head includes a first fork extending along a long direction of the handle and away from the end of the handle, and a rotating jaw rotatably mounted to the weeder head by an axle extending in a first direction perpendicular to the long direction of the handle, wherein the rotating jaw has a second fork displaced from the axle in a second direction perpendicular to the long direction of the handle and the first direction on a first side of the handle so that the second fork is displaced from the first fork when the second fork is rotated to be parallel to the first fork;
inserting the first fork and the second fork into the soil around the plant until contact is made with an edge of a lever extension of the rotating jaw that is mechanically coupled to and extending from the second fork to an end of the lever extension on a second side of the handle opposite the first side;
rotating the handle toward the soil to rotate the lever extension via contact of the edge of the lever extension with the soil, thereby causing a tip of the second fork to incline toward a tip of the first fork to close the first fork and the second fork around a plant; and
removing the loosened plant from the soil.

11. The method of claim 10, further comprising supporting the step with a curved support portion that extends from the axle to a first end of a step that extends to the handle at a second end thereof an in a direction perpendicular to the long direction of the handle, wherein the edge of the lever extension extends beyond the curved support portion of the step, so that the curved support portion of the step does not prevent contact of the soil with the edge of the lever extension during the rotating of the handle.

12. The method of claim 10, further comprising adjusting a distance between the tip of the first fork and a tip of the second fork with an adjustment mechanism, and thereby adjusting an initial rotation of the edge of the lever extension with respect to the handle.

13. The method of claim 10, wherein the rotating jaw is a first rotating jaw rotatably coupled to the axle at a first end of the axle, wherein the weeder head further comprises a second rotating jaw rotatably coupled to the axle at a second end of the axle, wherein the first rotating jaw is rigidly attached to a first side of the second fork and the second rotating jaw is rigidly attached to a second side of the second fork, so that the first and second rotating jaws pass on either side of the step when the handle is rotated with respect first lever extension and the second lever extension rotate due to contact of the edge of the first lever extension and a corresponding edge of the second lever extension with the soil.

14. The method of claim 13, wherein ends of the edge of the first lever extension and the corresponding edge of the second lever extension opposite the second fork are curved in a direction away from a tip of the second fork, so that as the handle is rotated toward the soil, an angular rotation of the second fork with respect to the first fork around the axle is reduced with respect to the rotation of the handle as the handle is rotated toward the soil.

15. The method of claim 11, wherein an end of the edge of the lever extension opposite the second fork is curved in a direction away from a tip of the second fork so that as the handle is rotated toward the soil, an angular rotation of the second fork with respect to the first fork around the axle is reduced with respect to the rotation of the handle as the handle is rotated toward the soil.

16. The method of claim 10, wherein the lever extension is rigidly coupled to the second fork.

17. The method of claim 10, further comprising:
removing the axle from the weeder head;
selecting one of a plurality of interchangeable fork assemblies;
installing the selected fork assembly and the axle on the weeder head.

18. The method of claim 17, wherein the plurality of interchangeable fork assemblies include fork assemblies having forks with differing tine lengths.

19. A weeder head for a weed-pulling tool, comprising:
a sleeve for accepting an elongate handle;
a first fork extending along a long direction of the handle and away from the sleeve;
a rotating jaw rotatably mounted to the sleeve by an axle extending in a first direction perpendicular to the long direction of the handle, wherein the rotating jaw has a second fork displaced from the axle in a second direction perpendicular to the long direction of the handle and perpendicular to the first direction on a first side of the sleeve, so that the second fork is displaced from the first fork when the second fork is rotated to be parallel to the first fork; and
a step rigidly affixed to the weeder head and extending along the second direction on a second side of the sleeve opposite the first side to provide a platform for applying foot pressure to insert the first and second forks in the soil prior to rotating the handle, wherein the rotating jaw has a lever extension mechanically coupled to and extending from the second fork to an end of the lever extension on the second side of the sleeve, so that the lever extension contacts the soil when the first fork and the second fork are fully inserted in the soil, and so that as the handle is rotated toward the soil, the lever extension rotates with respect to the sleeve due to contact of the edge of the lever extension with the soil and causes a tip of the second fork to incline toward a tip of the first fork to close the first fork and the second fork around a plant.

20. The weeder head of claim 19, wherein the rotating jaw is a first rotating jaw rotatably coupled to the axle at a first end of the axle, and wherein the weeder head further comprises a second rotating jaw rotatably coupled to the axle at a second end of the axle, wherein the first rotating jaw is rigidly attached to a first side of the second fork and the second rotating jaw is rigidly attached to a second side of the second fork, so that the first and second rotating jaws pass on either side of the step when the first lever extension and the second lever extension rotate with respect to the sleeve due to contact of the edge of the first lever extension and a corresponding edge of the second lever extension with the soil.
